(19) United States
(12) Patent Application Publication
(10) Pub. No.: US 2025/0341820 A1
(43) Pub. Date: Nov. 6, 2025

(54) AUTOMATED ANOMALY DETECTION AND RESOLUTION IN AN INDUSTRIAL AUTOMATION SYSTEM

(71) Applicant: Rockwell Automation Technologies, Inc., Mayfield Heights, OH (US)

(72) Inventors: Michael J. Anthony, Milwaukee, WI (US); Jonathan A. Mills, Mayfield Heights, OH (US); Patrick E. Ozimek, Elm Grove, WI (US); Clark L. Case, Aurora, OH (US)

(21) Appl. No.: 18/652,571

(22) Filed: May 1, 2024

(51) Int. Cl. G05B 19/418

(52) U.S. Cl. CPC G05B 19/4184

(57) ABSTRACT

Disclosed herein are methods and systems for automated anomaly detection and resolution for industrial device function. Where anomalies are detected, anomaly information is collected, including an anomaly description, an anomaly context, and a code block source of the anomaly. Anomaly information is used in generating prompts to be sent to a generative large language model (LLM) trained on anomaly data. The LLM is configured to accept a prompt containing anomaly information and return a reference anomaly solution selected for its similarity to the target anomaly. The reference anomaly solution, containing control logic that governs industrial device function, is tailored for the target anomaly. The tailored reference anomaly solution, now acting as the target anomaly solution, is deployed to the industrial controller associated with the industrial device experiencing anomalous function. The control logic of the target anomaly solution replaces existing control logic, thereby eliminating the anomaly.

### TECHNICAL FIELD

Various embodiments of the present technology generally relate to the detection and resolution of anomalies in industrial device function caused by flawed control code logic. More specifically, embodiments include automated anomaly detection and resolution methods and systems for detecting a target anomaly in an industrial automation system, identifying a reference anomaly solution, generating a target anomaly solution, and deploying the target anomaly solution.

### BACKGROUND

Industrial automation environments are environments where industrial devices operate under the management of industrial automation systems via control software. Control software (i.e., control code) is software that uses control logic to dictate the operations of a device or program. Control logic is deployed to logic controllers, allowing a given controller to dictate the behavior of an associated industrial device. As new industrial technology develops, and industrial automation systems grow in complexity, flawed control logic is an increasingly common cause of anomalies in industrial automation environments. An anomaly is any unintended or unexpected function of an industrial device. Anomalies can have substantial negative effects on the efficiency, profitability, flexibility, and safety of industrial automation environments.

Identifying anomalies in control logic, evaluating the solutions to remedy anomalies, developing the solutions, and deploying the solutions to the appropriate logic controllers for the industrial device experiencing anomalous behavior is tedious and resource intensive. Additionally, duplicative effort may be spent developing anomaly solutions where anomalies have similar root causes. Even where anomalies are detected and solutions are developed to remedy them, fully remedying an anomaly can require multiple rounds of revision and observation to debug the solution, compounding the resource and labor cost of curing the anomaly.

Accordingly, improvements are needed for automated anomaly detection and resolution.

### SUMMARY

Systems and methods are provided herein for automated detection and resolution of anomalies in industrial device function caused by flawed control logic. The automated anomaly detection and resolution system observes an industrial automation environment, detects anomalies in the environment, generates a solution for the detected anomaly using one or more reference anomalies, and deploys the solution to a logic controller for the device associated with the anomaly. The solution has modified control logic that replaces the control logic currently used to govern industrial device behavior. As such, the automated anomaly detection and resolution system automatically resolves anomaly causing control code flaws without user oversight. Methods of applying the automated anomaly detection and resolution system are provided herein.

The automated anomaly detection and resolution system anomalies detects anomalies through an automated analysis of the control logic codebase underlying industrial automation system. A user or administrator may also initiate an analysis of the control logic codebase. Anomaly detection may be further performed by polling for faults on logic controllers. Note that in some cases, an anomaly is the occurrence of a logic fault, etc., while in other cases, an anomaly can be detected for conditions precedent to an anomaly. Where the anomaly detected is an anomalous condition that leads to an actual anomaly occurrence, recognizing the anomalous condition, or precedent condition, as a detriment is beneficial to the anomaly detection system. Precedent conditions include a precedent logical state, precedent register values, and precedent actions. Where anomalous precedent conditions are remedied, the occurrence of the anomaly caused by the precedent conditions may be mitigated entirely. In some other cases, a precedent condition that leads to an anomaly is another anomaly. Where anomalous condition constitutes a precedent anomaly, remedying the precedent anomaly mitigates harm from both the precedent anomaly and the resulting anomaly.

Where a target anomaly is detected, the anomaly detection engine gathers certain information to use as a basis for generating a target solution. This information includes a target anomaly context, a target anomaly description, and a code block giving rise to the anomaly. This information is received at the anomaly solution engine where it is used as the basis to query a central anomaly index. In response to receiving the information about the target anomaly, the anomaly solution engine selects a reference anomaly from the central anomaly index specifically for its similarity to the target anomaly. The reference anomaly is selected with regard to the target anomaly context, the target anomaly description, and the code block giving rise to the anomaly. Having received back the reference anomaly solution from the central anomaly index, the anomaly solution engine tailors the solution for application to the target anomaly. The reference anomaly is tailored for the target anomaly based on the target anomaly context, the target anomaly description, and the code block giving rise to the anomaly. The target anomaly solution is deployed to the logic controller, where the newly modified control code replaces the existing anomaly causing control code.

In some instances of the systems and methods provided herein, deploying the control code to the logic controller further includes a debug loop. Once the solution is deployed to the IAS, its performance is evaluated. In response to performance below a predetermined threshold when compared to the reference anomaly solution, the solution is further modified and redeployed. The debug loop is repeated until the difference between the target anomaly solution and the reference anomaly solution is below a predetermined level.

In some instances of the systems and methods provided herein, identifying the reference anomaly further includes querying the central anomaly index for a set of reference anomalies instead of a single reference. Each reference anomaly of the set of reference anomalies is compared with the target anomaly. With regard to the target anomaly context, target anomaly description, and code block giving rise to the target anomaly, each reference anomaly of the set of reference anomalies is ranked for its similarity to the target anomaly. The reference anomaly with the highest rank of similarity to the target anomaly is returned as the reference anomaly.

In some instances of the systems and methods provided herein, detecting the target anomaly further includes storing the detected anomaly information, including the target anomaly context, the target anomaly description, and the code block giving rise to the anomaly in an anomaly logger. Stored information may include target anomaly descriptions, target anomaly contexts, and code blocks giving rise to target anomalies.

In some instances of the systems and methods provided herein, anomalies may take the form of logic faults, nonconforming data entries, unexpected behaviors, nonconforming outputs, or a combination of one or more of those issues. A nonconforming data entry may be one where the data is beyond an expected value range, the data is an incorrect or unreadable form, and the like. Similarly, a nonconforming output may include data beyond an expected value range, data in an incorrect or unreadable form, and the like. A present logical state refers to the state of a device where the state may lead to an anomaly.

In some instances of the systems and methods provided herein, anomaly detection can be carried out by automated polling of the IAS, by a user-initiated analysis of the code base, or by a combination thereof.

In some instances of the systems and methods provided herein, the topology of the IAS where the target anomaly is occurring is replicated at the central anomaly index to further inform selections of reference anomalies.

In some instances of the systems and methods provided herein, training data for the anomaly solution engine includes safety standards, industry standards, best practices, internal procedures, internal documentation, device documentation, or a combination of one or more of these.

In some instances of the systems and methods provided herein, the anomaly detection engine is trained by data from the central anomaly index.

In some instances of the systems and methods provided herein, once an anomaly is logged and the anomaly solution is determined to remedy the anomaly, the logged information is fed back to the central anomaly index as further training data.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a system diagram of an example application of the automated anomaly detection and resolution system in accordance with some embodiments of the present technology.

FIG. 2 illustrates a system diagram of an example application of the automated anomaly detection and resolution system in further detail in accordance with some embodiments of the present technology.

FIG. 3 illustrates a method diagram of an example application of the automated anomaly detection and resolution system in accordance with some embodiments of the present technology.

FIG. 4 illustrates a method diagram of a further example application of the automated anomaly detection and resolution system in accordance with some embodiments of the present technology.

FIG. 5 illustrates a method diagram of a further example application of the automated anomaly detection and resolution system in accordance with some embodiments of the present technology.

FIG. 6 illustrates a software flow diagram of an example application of the automated anomaly detection and resolution system in accordance with some embodiments of the present technology.

FIG. 7 illustrates a software flow diagram of a further example application of the automated anomaly detection and resolution system in accordance with some embodiments of the present technology.

FIG. 8 illustrates a software flow diagram of a further example application of the automated anomaly detection and resolution system in some embodiments of the present technology.

FIG. 9 illustrates an example computing system used in some embodiments of the present technology.

### DETAILED DESCRIPTION

As described above, various embodiments of the present technology generally relate to methods and systems for automatically detecting and resolving anomalies in industrial device function caused by incorrect, inefficient, or otherwise flawed control logic.

Industrial automation environments are environments in which industrial controllers implement control code software to govern the behavior of industrial devices. Control code software is made up of rules and parameters that dictate when and how an industrial device will perform certain actions or enter certain states. Control code can be developed on remotely located devices, or devices on the premises of an industrial automation environment. Developed control code intended for a specific industrial device is deployed to an industrial controller associated with that industrial device. The industrial controller executes the control code with regard to the industrial device, thereby dictating its function.

As new industrial technology develops, and industrial automation systems become increasingly complex, flawed control logic is an increasingly common cause of anomalies in industrial environments. Control logic, particularly for complex industrial automation environments, is rarely sufficient immediately after being written and commonly requires debugging and revision to achieve their intended outcomes. Flawed control logic can create issues in an industrial automation environment, including problems with industrial device functionality, device control problems, damaging devices or components, loss of efficiency, and the like. These problems can be generally referred to as anomalies. An anomaly in an industrial device's function may be the result of flawed or imperfect control logic deployed to the industrial controller responsible for governing that devices behavior.

Anomalies can have substantial negative effects on the industrial automation environment including inefficiency, lower profitability, inflexibility, safety, and the like. Industrial automation environments where groups of industrial devices work in collaboration are particularly vulnerable to the harm caused by anomalous function. Where one device is experiencing an anomaly, the performance of another device not experiencing any abnormal behavior may be undermined as a result of connectivity with the anomalous device. In some cases, an anomaly may not be with a specific device's function, but rather the function of a group or system whose behavior is governed by one or more logic controllers. Further, an anomaly that appears to be within one industrial device may be the result of flawed control logic used to control a different industrial device earlier in the industrial automation process.

Identifying anomalies in control logic, evaluating the solutions necessary to remedy anomalies, developing the required solutions, and deploying solutions to the appropriate logic controllers is tedious and resource intensive. To combat these issues, this disclosure includes methods and systems for automated anomaly detection and resolution for control code in industrial automation systems. The system observes an industrial automation environment and detects anomalies via an anomaly detection engine. The anomaly detection engine detects anomalies through an automated polling of the codebase of control code, a user-initiated polling of the codebase of control code, by polling for logic faults on controllers, by a user input, or by other methods for sensing or evaluating industrial device function. Hereinafter, the anomaly detected in the function of a device in an industrial automation system is referred to as the target anomaly.

In response to the anomaly detection engine detecting a target anomaly in the function of an industrial device in an industrial automation environment, several pieces of target anomaly information are collected. Examples of the information collected for the target anomaly include a target anomaly context, a target anomaly description, and a code block giving rise to the target anomaly. A target anomaly context includes information about the device or devices the anomaly is associated with, the nature of the device and its relation to other devices, typical behavior of the device, expected outcomes of the device function, and the like. A target anomaly description includes information about the nature of the anomaly and the anomaly's effects on one or more devices in the industrial automation environment. A code block giving rise to the anomaly includes the software responsible for governing the behavior of the device experiencing anomalous function. In some examples of the technology described herein, the information gathered about the target anomaly is logged for subsequent analysis.

The anomaly detection engine sends the target anomaly information to an anomaly solution engine for processing and identification of a reference anomaly. Internal communication in the automated anomaly detection and resolution system is facilitated by a user interface and internal communication module. In some examples of the automated anomaly detection and resolution system, the anomaly detection engine and anomaly solution engine are communicatively coupled and transmit messages to each other directly.

The target anomaly information is received at the anomaly solution engine by an index query module. The index query module uses the target anomaly information to produce a prompt that directs the central anomaly index to return a reference anomaly solution. The central anomaly index is a generative large language artificial intelligence model trained on a large volume of anomaly information and respective solutions. In some examples of the present technology, the training data for the central anomaly index includes industry best practices, internal standards, and anomaly databases. One such anomaly database used for training the central anomaly index is maintained by Rockwell Automation using Atlassian's Jira project management platform. Other databases and applications storing anomaly information and anomaly solutions may additionally be leveraged to train the central anomaly index. Upon receiving the target anomaly information, the index query module generates a prompt that directs the central anomaly index to return a reference anomaly solution.

In response to receiving the prompt from the index query module, the central anomaly index returns a reference anomaly solution to be used as a starting point for the target anomaly solution. In some instances of the present technology, the central anomaly index evaluates the target anomaly information contained in the prompt and returns a single reference anomaly. Which reference anomaly the central anomaly index returns is determined with regard to the target anomaly context, target anomaly description, and code block giving rise to the target anomaly. The selected reference anomaly is identified for its similarity to the target anomaly based on a comparison of respective anomaly information. Once the reference anomaly is identified, the solution associated with the reference anomaly is returned to a solution tailoring module for further processing.

In some embodiments of the present technology, the index query module prompts the central anomaly index to return a set of reference anomalies. The response of the central anomaly index further includes anomaly information for each anomaly in the set of reference anomalies. A comparison module evaluates the set of reference anomalies by comparing the target anomaly information and the anomaly information for each respective reference anomaly in the set of references anomalies. Each reference anomaly of the set of reference anomalies is then ranked by a ranking module for its similarity to the target anomaly based on this comparison. The reference anomaly with the highest highest degree of similarity to the target anomaly receives the highest ranking. The ranking module transmits the solution associated with the highest ranked reference anomaly to the solution tailoring module for continued processing.

In response to receiving a reference anomaly solution, the solution tailoring module modifies the reference anomaly solution to generate a target anomaly solution. The reference anomaly solution is modified with respect to one or more of the target anomaly context, the target anomaly description, and the code block giving rise to the target anomaly. The reference anomaly solution is modified before being deployed as the target anomaly solution to increase the likelihood that the target anomaly solution remedies the target anomaly without further input or oversight. In some embodiments of the present technology, deploying the target anomaly solution further includes executing a debug loop. The debug loop comprises deploying the target anomaly solution to the industrial controller associated with the industrial device experiencing anomalous function and comparing the application of the target anomaly solution with the reference anomaly solution. Where the differences between the application of the target anomaly solution and the reference anomaly solution exceed a threshold, the solution tailoring module further modifies the target anomaly solution to emulate the reference anomaly solution. Once the latest modification of the target anomaly solution is complete, the newly updated target anomaly solution is deployed to the appropriate controller for execution. The application of the modified target anomaly solution is observed and again compared with the reference anomaly solution. Where the differences between the application of the target anomaly solution and the reference anomaly solution are below a threshold, the system exits the debug loop.

In some embodiments of the present technology, newly developed target anomaly solutions and their respective anomaly information are used as further training data for the central anomaly index. Upon detecting and generating a solution for a particular target anomaly, the automated anomaly detection and resolution system collects the target anomaly information and the newly created target anomaly solution and transmits them to the central anomaly index as supplementary training data. Beneficially, this promotes the improvement of the automated anomaly detection and resolution system's ability to accurately evaluate anomaly information and return relevant reference anomaly solutions. Each additional anomaly and respective anomaly information that is added to the training data for the central anomaly index strengthens the model's ability to correlate various anomalies and their solutions.

The system and method technology disclosed herein relate to the field of anomaly detection and resolution in industrial automation systems. Particularly, automated anomaly detection and resolution of anomalous function in industrial devices governed by control logic on industrial controllers. The invention significantly reduces the time and resource cost of recognizing anomalies, developing anomaly solutions, and deploying anomaly solutions to relevant controllers to remedy anomalies in industrial device function. Specifically, beyond the human resources saved, computational resources are reduced because a solution that is already tailored to the specific issue is generated and propagated to the industrial controller for use in the industrial automation process. The present system reduces bandwidth, memory resources, and processor resources historically needed for generating, testing, debugging, and retesting repeatedly solutions for resolving an anomaly. Furthermore, anomalies are identified early thereby saving inefficiencies of damaged equipment, inefficiencies of a process that is not optimized, and the like. Note that while in some examples the anomaly solution is deployed to a controller in order to rectify the target anomaly, in other examples, the anomaly solution is deployed to an industrial device to rectify the target anomaly. Further, in some examples, the anomaly solution may be deployed to both an industrial device and an associated controller in order to rectify the target anomaly. Generally, the anomaly solution can be deployed to any hardware, software, or firmware process that executes modifiable control logic that results in anomalies in industrial device function or in an industrial process.

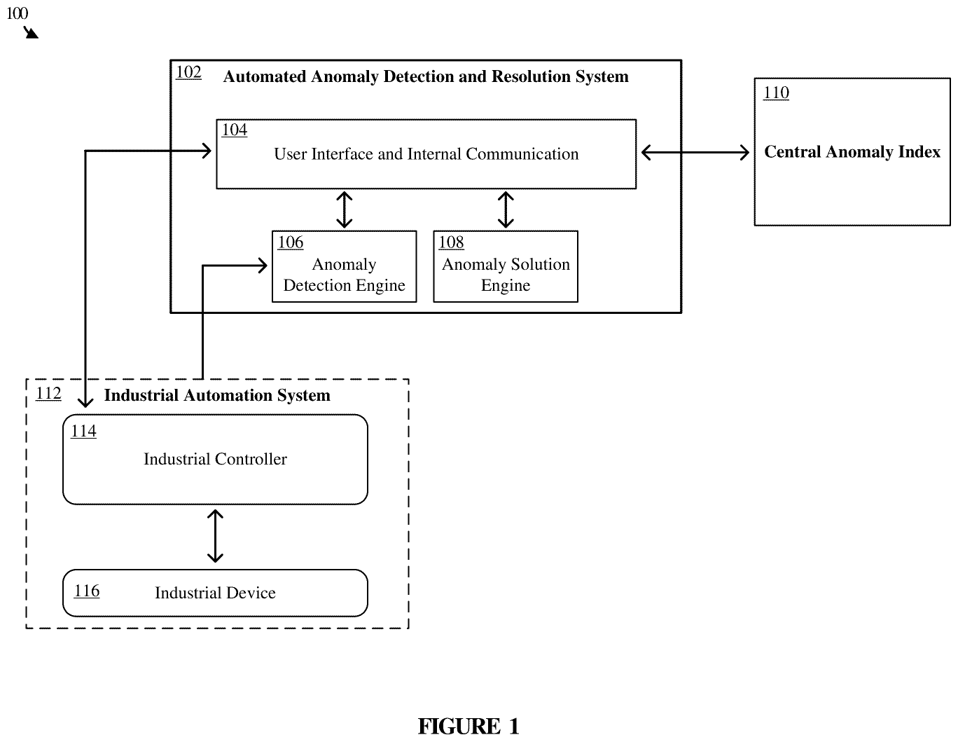

Now turning to the figures, FIG. 1 illustrates example application of the automated anomaly detection and resolution system 100 in accordance with some embodiments of the present technology. Example application of the automated anomaly detection and resolution system 100 includes automated anomaly detection and resolution system 102, central anomaly index 110, and industrial automation system 112.

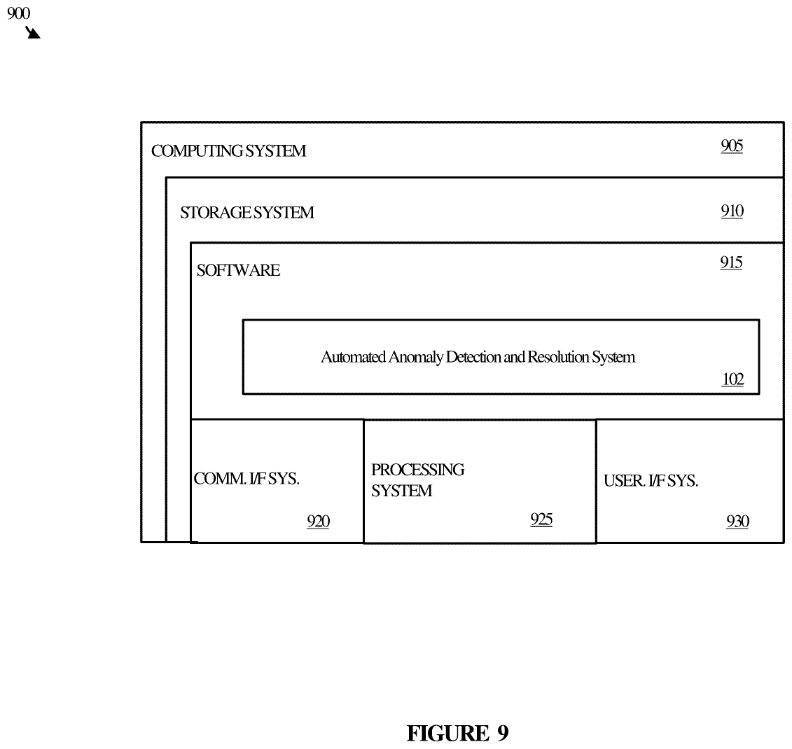

Automated anomaly detection and resolution system 102 is responsible for detecting anomalies in industrial automation system 112 and leveraging central anomaly index 110 to generate a tailored solution to remedy the anomaly. Automated anomaly detection and resolution system 102 may be implemented as any one or combination of hardware, firmware, or software. In some examples, automated anomaly detection and resolution system 102 is local to the premises of an industrial automation environment. In other examples, automated anomaly detection and resolution system 102 is hosted remotely. In yet more examples, automated anomaly detection and resolution system 102 is distributed among multiple computing devices. Example computing system 905 of FIG. 9 is generally representative of such computing devices described herein. Example computing system 905 is described in greater detail in the text associated with FIG. 9.

Automated anomaly detection and resolution system 102 further includes user interface and internal communication 104, anomaly detection engine 106, and anomaly solution engine 108. User interface and internal communication 104 facilitates communication both between automated anomaly detection and resolution system 102 and central anomaly index 110 or industrial automation system 112, but also communication between internal elements of automated anomaly detection and resolution system 102. These communication paths could be part of a wired local area network (LAN) or alternatively part of a wireless LAN. For example, where an anomaly is detected by anomaly detection engine 106, anomaly information is received at anomaly solution engine 108 via user interface and internal communication 104. In another example, where the anomaly solution engine has generated a target anomaly solution, the target anomaly solution is received at industrial automation system 112 via user interface and internal communication 104. Anomaly detection engine 106 observes industrial automation system 112 for anomalies. Anomaly detection engine 106 detects anomalies through one or more of an automated polling of the codebase of control code, a user-initiated polling of the codebase of control code, by polling for logic faults on industrial controllers (e.g., industrial controller 114), by a user input, or by other methods for sensing or evaluating industrial device function. A logic fault occurs where the logic controller recognizes a problem with the logic being executed. For example, an industrial controller 114 of industrial automation system 112 experiences a fault and raises a flag indicating the fault's existence. During a polling of the industrial automation system 112, anomaly detection engine 106 recognizes the raised fault flag and begins to collect anomaly information. In another example, a dispenser device's output may be substantially diminished as a result of inferior control logic. Anomaly detection engine 106 recognizes the unintentionally diminished output capacity for the device, and, where the diminished output exceeds a pre-determined threshold, triggers the procedure for automated anomaly detection and resolution.

Central anomaly index 110 is a generative large language artificial intelligence model trained on a variety of training data and configured to accept and input of a target anomaly and target anomaly information and, in response, to output a reference anomaly solution. Training data for central anomaly index 110 is described in greater detail below. In an example, a target anomaly relating to a jammed dispensing device in an industrial automation environment could be detected. In such an example, central anomaly index 110 receives a prompt containing a description, context, and catalyzing code block for the target anomaly. In response, central anomaly index 110 returns a reference anomaly solution associated with a reference anomaly identified as similar to the target anomaly. This evaluation is based on one or more of the target anomaly description, the target anomaly context, and the code block giving rise to the anomaly. In some embodiments, central anomaly index 110 receives a prompt requesting a set of reference anomalies instead of a single reference anomaly solution. In an example of such an embodiment, a target anomaly relating to a jammed dispensing device in an industrial automation environment could be detected. Central anomaly index 110 is queried for a set of reference anomalies, and in response, returns a set of reference anomalies for subsequent processing. Central anomaly index 110 is managed remotely from the industrial automation environment but could also be implemented on the industrial automation environment's premises. Central anomaly index 110 could be stored in localized storage or in distributed storage.

Generative artificial intelligence (GAI) models (also known as foundation models) are models trained to generate new data based on a training dataset. GAI models as used herein include large-scale generative artificial intelligence (AI) models trained on massive quantities of diverse, unlabeled data. The GAI models learn using self-supervised, semi-supervised, or unsupervised techniques. GAI models perform many downstream tasks based on capturing general knowledge, semantic representations, and patterns and regularities in the training data. In some embodiments, such as embodiments included herein, a GAI model may be fine-tuned for specific downstream tasks. GAI models include BERT (Bidirectional Encoder Representations from Transformers) and ResNet (Residual Neural Network). GAI models may be based on any relevant architecture, including, for example, generative adversarial networks (GANs), variational auto-encoders (VAEs), and transformer models, including multimodal transformer models. Depending on the type of input accepted and output provided, GAI models may be multimodal or unimodal.

Multimodal models are a class of GAI model that accept multimodal data including text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of a given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video—generating a text description of the video or generating video based on a text description.

Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of GAI model that process and generate natural language text. These models are trained on massive amounts of textual data. LLMs learn to generate relevant responses given a prompt or input text. The responses are coherent and contextually relevant to the given prompt. LLMs understand and generate sophisticated language based on their training. LLMs capture intricate patterns, semantics, and contextual dependencies in textual data. In some cases, LLMs may be used in multimodel models. For example, the LLM intelligence is used to combine images and audio input with textual input to generate multimodal output. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. For example, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses that are creative, open-ended, and unpredictable.

Industrial automation system 112 includes a network including one or more industrial devices 116 governed by one or more industrial controllers 114. Industrial automation system 112 may contain any number and variety of industrial devices 116, all of which is governed by one or more industrial controllers 114. Industrial automation system 112 ties together industrial controller 114 and industrial device 116 such that device behavior can be dictated by control logic executed on the controller. Industrial automation system 112 may comprise one industrial environment, or a combination of industrial environments. Example application of the automated anomaly detection and resolution system 100 includes just one industrial automation system 112 governing a single industrial environment, further comprising one industrial controller 114 and one industrial device 116. Example application of the automated anomaly detection and resolution system 100 could additionally include more than one industrial controller 114 and industrial device 116, but additional components are omitted for simplicity. While industrial controller 114 only governs the behavior of industrial device 116, industrial controller 114 could be tasked with governing many industrial devices. Further, some examples of present technology include an industrial controller 114 integrated directly into an industrial device 116. In such an example, user interface and internal communication 104 communicates directly with industrial device 116.

Industrial controller 114 is generally representative of any processing device sufficient to dictate the behavior of peripheral devices. For example, industrial controller 114 may be a programmable logic controller (PLC), or the like. In some embodiments, industrial controller 114 is embedded in industrial device 116. Accordingly, an industrial device 116 may include an industrial controller 114 that controls the behavior of the device. Industrial device 116 is generally representative of any device used in an industrial automation environment, such as robotic devices, conveyors, dispensers, motors, drives, and the like.

In use, industrial controller 114 is loaded with control logic such that when executed, the control logic governs the function of industrial device 116. While operating within the bounds of the control logic executed on industrial controller 114, industrial device 116 begins to function in a suboptimal way. For example, industrial device 116 could be a conveyor unit that is not moving items as anticipated. In this example, the target anomaly is the conveyor's inferior performance in shuttling items around the industrial automation environment. Anomaly detection engine 106, while observing industrial automation system 112, may recognize that the output of industrial device 116 has fallen below a predetermined threshold of acceptable performance variance. In response, anomaly detection engine 106 may collect anomaly information about the target anomaly for use in subsequent processing. Anomaly detection engine 106 may gather a target anomaly description, a target anomaly context, and a code block giving rise to the target anomaly. In the ongoing conveyor example, the anomaly description collected by anomaly detection engine 106 may describe the inferior output of industrial device 116 compared to expected output. Continuing the conveyor example, the target anomaly context describes the type of device that industrial device 116 is, relationships industrial device 116 has with other devices in the industrial automation environment, the expected behavior of the device, and the like. The code block giving rise to the anomaly is collected from the controller having executed it, which in this example is industrial controller 114.

Having received the target anomaly information from industrial automation system 112, anomaly detection engine 106 sends the target anomaly information to anomaly solution engine 108 via user interface and internal communication 104. In response to receiving the target anomaly information, anomaly solution engine 108 generates a prompt and sends the prompt to central anomaly index 110. The prompt includes the target anomaly information and a request directing central anomaly index 110 to return a reference anomaly solution. In response to receiving the prompt, central anomaly index 110 selects a reference anomaly for its similarity to the target anomaly based on target anomaly information and reference anomaly information. The solution associated with the reference anomaly selected by central anomaly index 110 is returned to anomaly solution engine 108 via user interface and internal communication 104. In the foregoing conveyor example, the returned reference anomaly solution is selected specifically because of the parallels between the target anomaly and the reference anomaly. The target anomaly is suboptimal conveyor performance, and the reference anomaly could be an issue occurring on a robotic device having a highly similar motor to the conveyor.

In response to receiving the reference anomaly solution, anomaly solution engine 108 modifies the reference anomaly solution for application to the target anomaly. Relying on one or more of the target anomaly description, the target anomaly context, and the code block giving rise to the anomaly, anomaly solution engine 108 makes changes to the control logic contained in the reference anomaly solution to tailor the solution specifically for application to the target anomaly. The newly modified anomaly solution is the target anomaly solution. The target anomaly solution is deployed to industrial controller 114 via user interface and internal communication 104. Upon execution at industrial controller 114, the modified control logic now governs industrial device 116, mitigating or entirely eliminating the target anomaly.

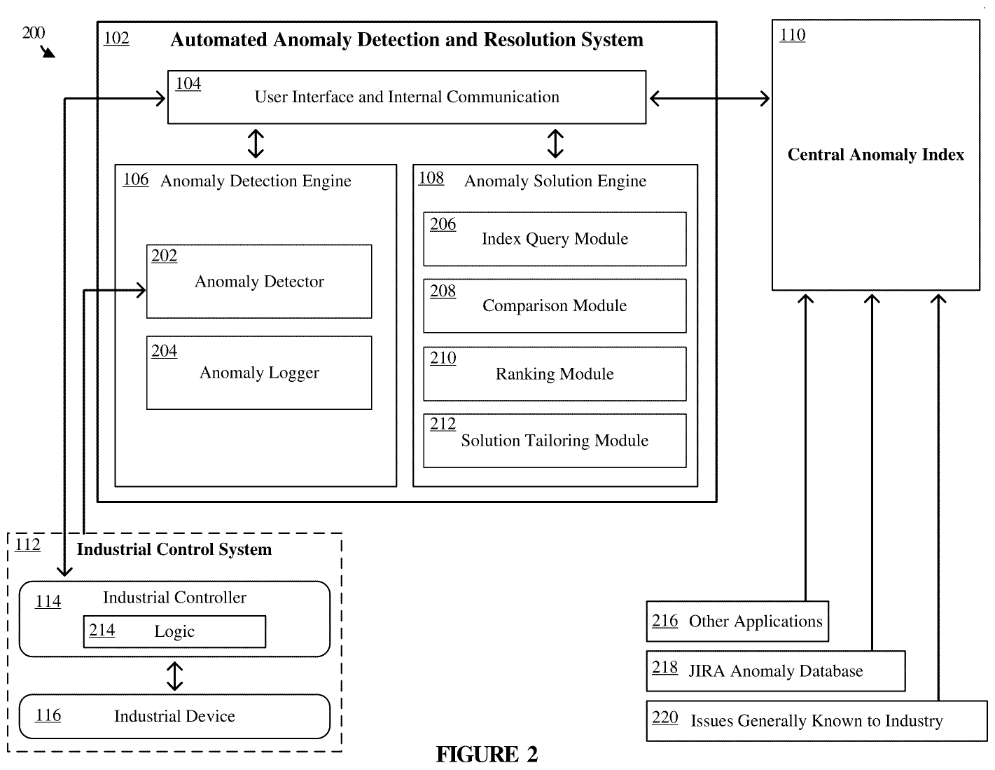

FIG. 2 illustrates example application of the automated anomaly detection and resolution system in further detail 200 in accordance with some embodiments of the present technology. Example application of the automated anomaly detection and resolution system in further detail 200 includes automated anomaly detection and resolution system 102, central anomaly index 110, and industrial automation system 112, as described in detail in the text associated with FIG. 1. Example application of the automated anomaly detection and resolution system in further detail 200 further includes other applications 216, Jira anomaly database 218, and issues generally known to industry 220. Other applications 216, Jira anomaly database 218, and issues generally known to industry 220 are sources of training data on which central anomaly index 110 is trained. Other applications could include project management or data storage platforms, on which information about anomalies is stored. An example of Jira anomaly database 218 is an instance of Atlassian's Jira project management platform maintained by Rockwell Automation. Issues generally known to industry 220 is training data made up of industry best practices known to those in the relevant fields. Best practices data can be obtained from industry publications, internal documentation, or academic publications, among other sources.

Automated anomaly detection and resolution system 102 includes user interface and internal communication 104, anomaly detection engine 106, and anomaly solution engine 108, all of which are described in detail in the text associated with FIG. 1. Anomaly detection engine 106 further includes anomaly detector 202, and anomaly logger 204. Anomaly detector 202 is tasked with observing industrial automation system 112 and triggering the automated anomaly detection and resolution process when an anomaly is recognized. For example, where industrial controller 114 raises a fault flag, anomaly detector 202 recognizes the raised flag and triggers the automated anomaly detection and resolution process by gathering anomaly information for the detected target anomaly. In some cases, upon detection of an anomaly, anomaly logger 204 stores the target anomaly information for subsequent review or model training purposes, among other uses. Anomaly detector 202 and anomaly logger 204 are implemented in software and could be local to the industrial automation environment or hosted on a remote computing device communicatively coupled with user interface and internal communication 104.

Anomaly solution engine 108 further includes index query module 206, comparison module 208, ranking module 210, and solution tailoring module 212. Index query module 206 receives the target anomaly information from anomaly detection engine 106 and generates a prompt to be sent to central anomaly index 110. Each of index query module 206, comparison module 208, ranking module 210, and solution tailoring module 212 are implemented in software and could be local to the industrial automation environment or hosted on a remote computing device communicatively coupled with user interface and internal communication 104.

Industrial automation system 112 includes industrial controller 114 and industrial device 116 as described in detail in the associated text to FIG. 1. Industrial controller 114 further includes logic 214. Logic 214 is generally representative of control logic used to govern the behavior of an industrial device. For example, where an industrial device is not permitted to operate above 50% of its maximum possible speed, logic 214 contains control logic that when executed, restricts the function of the industrial device to within the permitted parameters. Logic 214 is also the source of anomalies in the function of industrial device 116.

In use of an embodiment of the present technology, anomaly detector 202 recognizes an anomaly in the function of industrial device 116. Anomaly detector 202 collects a target anomaly description, a target anomaly context, and the code block giving rise to the anomaly. Logic 214 is the code block giving rise to the anomaly. As such, the target anomaly description, target anomaly context, and logic 214 are gathered and sent to anomaly solution engine 108 for processing. In some embodiments, the prompt generated by index query module 206 directs central anomaly index 110 to return a single reference anomaly solution. An example of such an embodiment in use is described in detail in the associated text to FIG. 1. In some other embodiments of the present technology, the prompt index query module 206 generates a prompt that instructs central anomaly index 110 to return a set of reference anomalies. The returned set of reference anomalies is received at comparison module 208. Comparison module 208 compares each of the reference anomalies of the set of reference anomalies with the target anomaly. Based on anomaly information for the target anomaly and for each reference anomaly of the set of reference anomalies, ranking module 210 ranks each reference anomaly for its degree of similarity to the target anomaly. The reference anomaly of the set of reference anomalies with the highest degree of similarity to the target anomaly is awarded the highest rank by ranking module 210. The highest ranked reference anomaly is selected as the reference anomaly and the associated anomaly solution is received at solution tailoring module 212. Solution tailoring module 212 modifies the control logic in the reference anomaly solution such that, when executed on industrial controller 114, anomalous behavior by industrial device 116 is remedied. The modifications made by solution tailoring module 212 are informed by one or more of the target anomaly description, the target anomaly context, and the code block giving rise to the target anomaly, logic 214.

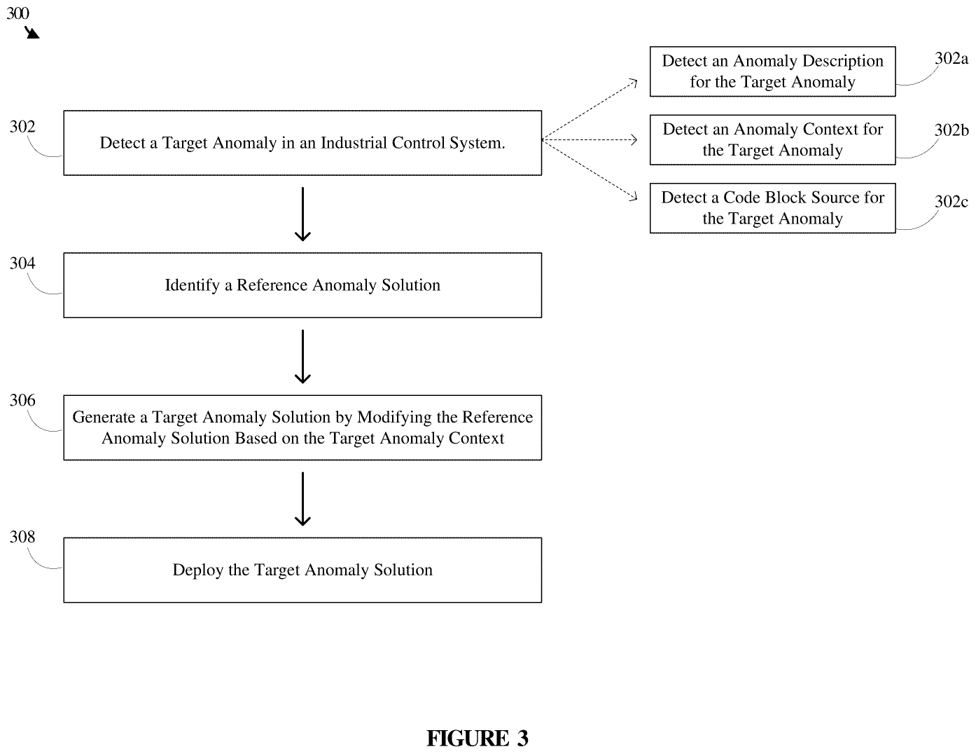

FIG. 3 illustrates method 300 depicting an example application of the automated anomaly detection and resolution system 100. Method 300 may be performed more specifically by automated anomaly detection and resolution system 102.

At step 302, a target anomaly is detected in an industrial automation system. The anomaly is associated with an industrial device, and the industrial device is associated with an industrial controller, such as industrial device 116 of FIG. 1 and industrial controller 114 of FIG. 1, respectively. Step 302 includes sub-steps 302a, 302b, and 302c. The detection of an anomaly comprises the detection of the target anomaly and collecting target anomaly information. Anomaly detection can be carried out by an anomaly detector, such as anomaly detector 202 of FIG. 2. At step 302a, an anomaly description for the target anomaly is collected. At step 302b, an anomaly context for the target anomaly is collected. At step 302c, a code block source of the anomaly is collected. Step 302 generally, and steps 302a, 302b, and 302c specifically, can be carried out by an anomaly detection engine having anomaly detector and anomaly logger subcomponents, such as anomaly detection engine 106 of FIG. 1. In some cases, the collected anomaly information described in steps 302a, 302b, and 302c is logged in an anomaly logger, such as anomaly logger 204 of FIG. 2.

At step 304, a reference anomaly solution is identified. The reference anomaly is identified with regard to one or more of the target anomaly description, the target anomaly context, and the code block source of the anomaly. An anomaly solution engine having an index query module and solution tailoring module, such as anomaly solution engine 108, receives the target anomaly information and generates a prompt for querying a central anomaly index. The prompt directs the central anomaly index to return a reference anomaly solution. The central anomaly index is configured to accept the target anomaly information as an input, and based on the information, return a reference anomaly solution selected for the reference anomaly's similarity to the target anomaly. An example of such a central anomaly index is central anomaly index 110 of FIG. 1. The reference anomaly solution returned by the central anomaly index is received at the anomaly solution engine. The reference anomaly solution includes control logic configured to facilitate anomaly-free function in industrial devices.

At step 306, in response to receiving the reference anomaly solution at the anomaly solution engine, the reference anomaly solution is tailored for application to the target anomaly by a solution tailoring module, such as solution tailoring module 212 of FIG. 2. Tailoring the reference anomaly solution for application to the target anomaly is completed with respect to one or more of the target anomaly description, the target anomaly context, and the code block source of the anomaly. Tailoring the reference anomaly solution for application to the target anomaly includes modifying the control logic in the reference anomaly solution to account for differences between the reference anomaly description and context compared to the target anomaly description and context.

At step 308, in response to the solution tailoring module modifying the reference anomaly solution for application to the target anomaly, the newly formed target anomaly solution is deployed to the target anomaly. Deploying the target anomaly solution to the target anomaly comprises sending the target anomaly solution to the controller associated with the industrial device experiencing anomalous function. The control logic of the target anomaly solution replaces the control logic currently governing the industrial device and causing the anomaly. For example, such control logic could be logic 214 of FIG. 2, which could be hosted on industrial controller 114 of FIG. 1, which could be associated with industrial device 116 of FIG. 1. Upon execution at the controller, the new control logic directs the industrial device to function in an anomaly free manner.

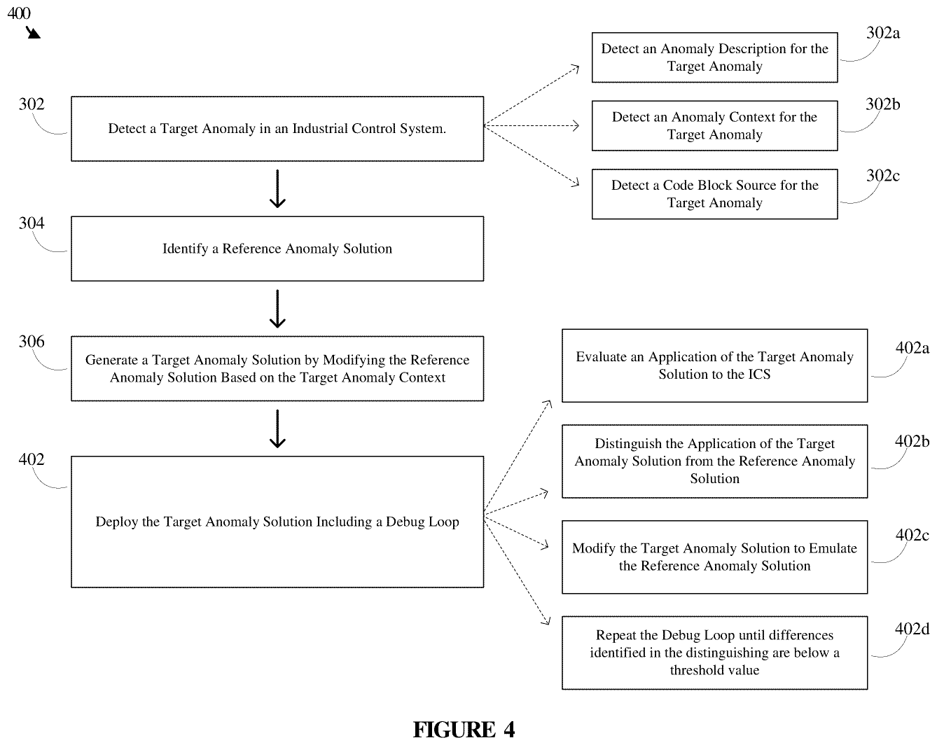

FIG. 4 illustrates method 400 depicting a further example application of the automated anomaly detection and resolution system 100. Method 300 may be performed more specifically by automated anomaly detection and resolution system 102. Method 400 may be similar to method 300 except that method 400 includes step 402 instead of step 308.

At step 402, the target anomaly solution is deployed, and a debug loop is entered. Step 402 includes step 402a, step 402b, step 402c, step 402d. The debug loop automatically resolves integration problems when deploying a target anomaly solution. Deploying the target anomaly solution at step 402 comprises executing the target anomaly solution on the industrial controller associated with the industrial device experiencing anomalous function. At step 402a, the execution of the target anomaly solution is evaluated. Evaluating the execution of the target anomaly solution includes monitoring the industrial controller for subsequent logic faults, observing outputs, and the like. Evaluating the application of the target anomaly solution is carried out by a solution tailoring module, such as solution tailoring module 212. Other components of the system could be tasked with evaluating the application of the target anomaly solution, like an anomaly detector such as anomaly detector 202.

At step 402b, the application of the target anomaly solution is compared with the reference anomaly solution. Differences between the target anomaly solution application and reference anomaly solution are evaluated. Examples of the differences between the target anomaly solution application and the reference anomaly solution include incomplete remediation of the anomaly in the target anomaly solution application when compared to the reference anomaly solution.

At step 402c, where the variance between the target anomaly solution application and reference anomaly solution exceeds a pre-determined threshold, the solution tailoring module again modifies the target anomaly solution such that it emulates the solution in the reference anomaly solution.

At step 402d, in response to the most recent modifications to the target anomaly solution, the target anomaly solution is redeployed to the industrial controller, and the loop repeats. Once the variance identified by a comparison of the target anomaly solution application and reference anomaly solution is below the pre-determined threshold, the system exits the debug loop.

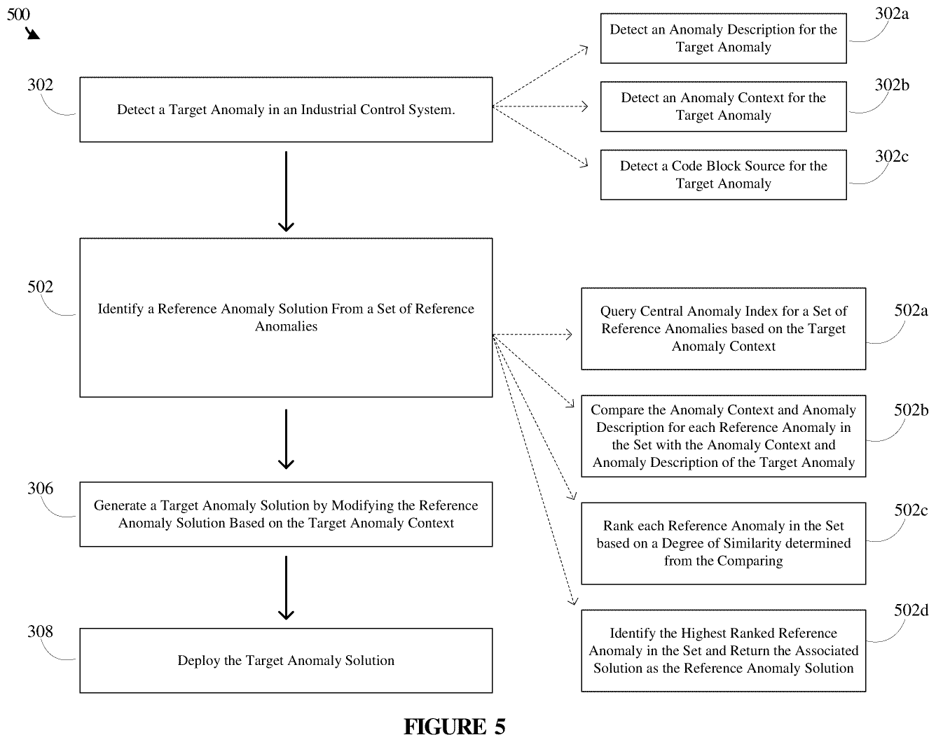

FIG. 5 illustrates method 500 depicting a further example application of the automated anomaly detection and resolution system 100. Method 500 may be performed more specifically by automated anomaly detection and resolution system 102. Method 500 may be similar to method 300 except that method 500 includes step 502 instead of step 304.

At step 502, the reference anomaly solution is chosen from a set of reference anomalies. Step 502 further includes step 502a, step 502b, step 502c, and step 502d. At step 502a, the central anomaly index is queried by an index query module, such as central anomaly index 110 of FIG. 1 and index query module 206 of FIG. 2, respectively. In this embodiment, the prompt generated at the index query module directs the central anomaly index to return a set of reference anomalies, as opposed to the single reference anomaly solution requested in step 304 of FIG. 3. The central anomaly index returns the set of reference anomalies, which are received at a comparison module, such as comparison module 208 of FIG. 2.

At step 502b, the comparison module evaluates each reference anomaly of the set of reference anomalies to the target anomaly by comparing anomaly information for each reference anomaly to anomaly information for the target anomaly. The anomaly information used in the comparison includes one or more of the anomaly description, the anomaly context, and the code block source of the anomaly. The evaluations of each reference anomaly of the set of reference anomalies are received at a ranking module, such as ranking module 210.

At step 502c, each reference anomaly of the set of reference anomalies is ranked for its similarity to the target anomaly based on the comparisons in each evaluation completed at step 502b. The reference anomaly that is the most similar to the target anomaly relative to the other reference anomalies in the set of reference anomalies is awarded the highest ranking. The reference anomaly with the highest ranking is selected as the reference anomaly, and the associated reference anomaly solution is received at the solution tailoring module for further processing. Step 306 and step 308 describe the next actions of method diagram of a further example application of the automated anomaly detection and resolution system 100 and are described in greater detail in the associated text to FIG. 3.

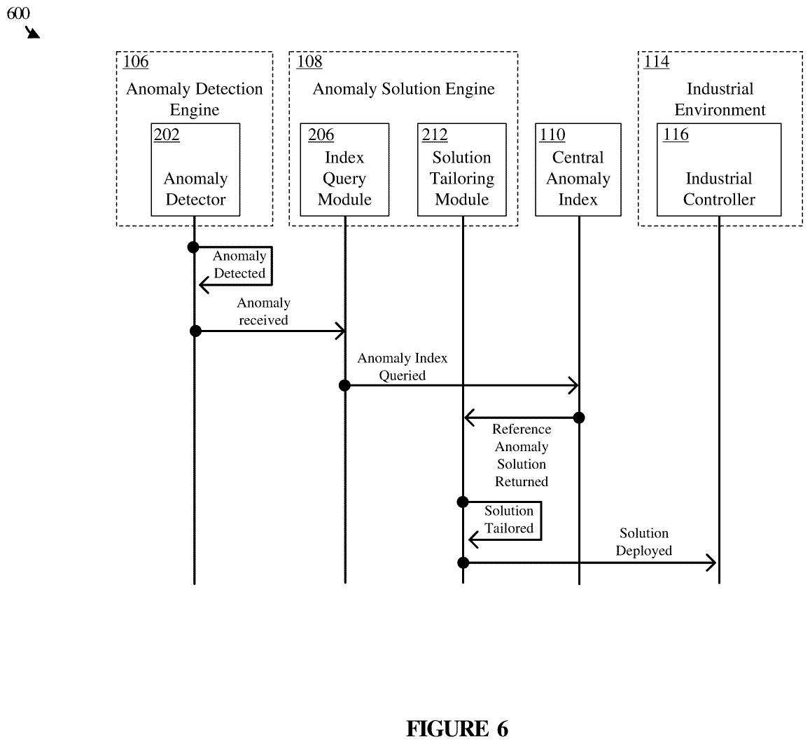

FIG. 6 illustrates software flow diagram 600 depicting an example data flow through automated anomaly detection and resolution system 100 in accordance with some embodiments of the present technology. Flow diagram 600 corresponds with method 300. Anomaly detection engine 106, which includes anomaly detector 202, detects an anomaly in the function of an industrial device. Anomaly detection can be facilitated by automated or user triggered code base polling, fault polling, or by user input, among other alternatives. Once an anomaly is detected, anomaly detector 202 collects anomaly information about the target anomaly. Target anomaly information includes a target anomaly description, a target anomaly context, and a code block source of the target anomaly.

The target anomaly information is sent from anomaly detector 202 to index query module 206 of anomaly solution engine 108. Index query module 206 generates a prompt including the target anomaly information and instructions to return a reference anomaly solution. The prompt is sent from index query module 206 to central anomaly index 110. In response to receiving the prompt, central anomaly index identifies a reference anomaly based on a degree of similarity to the target anomaly. A reference anomaly's similarity to the target anomaly is evaluated with respect to the target anomaly information, including one or more of anomaly descriptions, anomaly contexts, and code block sources of anomalies. Upon identifying the reference anomaly, the associated reference anomaly solution is returned. The reference anomaly solution includes control logic, that when executed on the controller associated with the industrial device experiencing anomalous behavior, remedies the anomaly.

Central anomaly index 110 returns the reference anomaly solution to solution tailoring module 212. In response to receiving the reference anomaly solution, solution tailoring module 212 modifies the control logic in the reference anomaly solution for application to the target anomaly. The tailored reference anomaly solution is the target anomaly solution. Once tailored, the target anomaly solution is deployed to industrial controller 114 for execution.

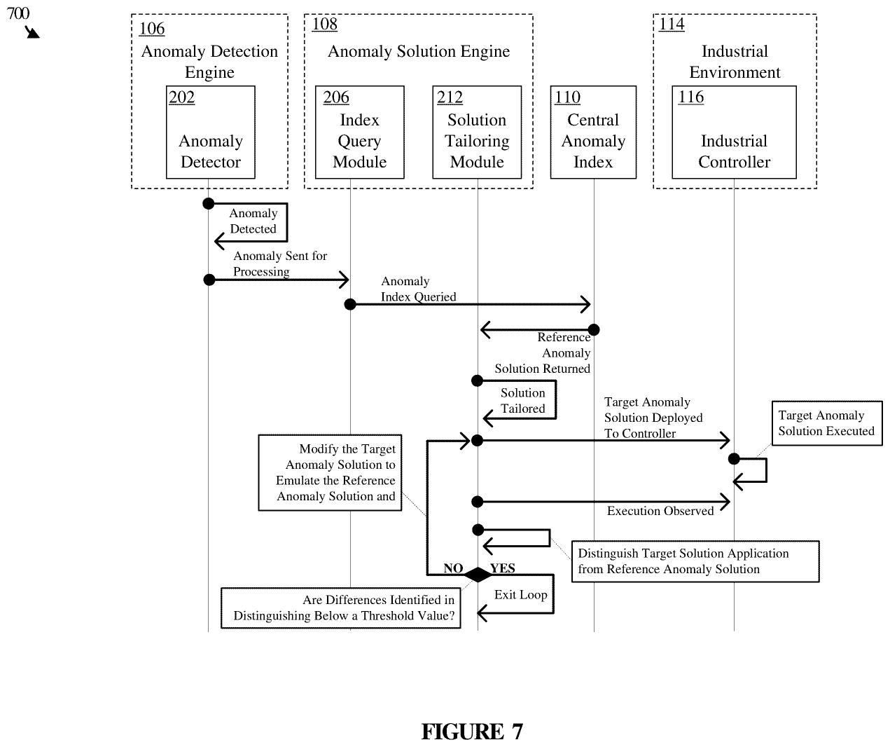

FIG. 7 illustrates software flow diagram 700 depicting a further example application of the automated anomaly detection and resolution system 100. Flow diagram 700 corresponds with method 400. Flow diagrams 600 and 700 are the same up to the deployment of the target anomaly solution. In flow diagram 700, deployment of the target anomaly solution triggers entry into a debug loop. The application of the target anomaly solution is observed by solution tailoring module 212. Solution tailoring module 212 then evaluates the differences between the application of the target anomaly solution and the reference anomaly solution. Where the variance between the two solutions exceeds a pre-determined threshold, the control logic of the target anomaly solution is further modified to emulate the reference anomaly solution. The newly modified target anomaly solution is then deployed to the industrial controller for execution, and the loop repeats. The system exits the debug loop when the variance between the two solutions is below the pre-determined threshold.

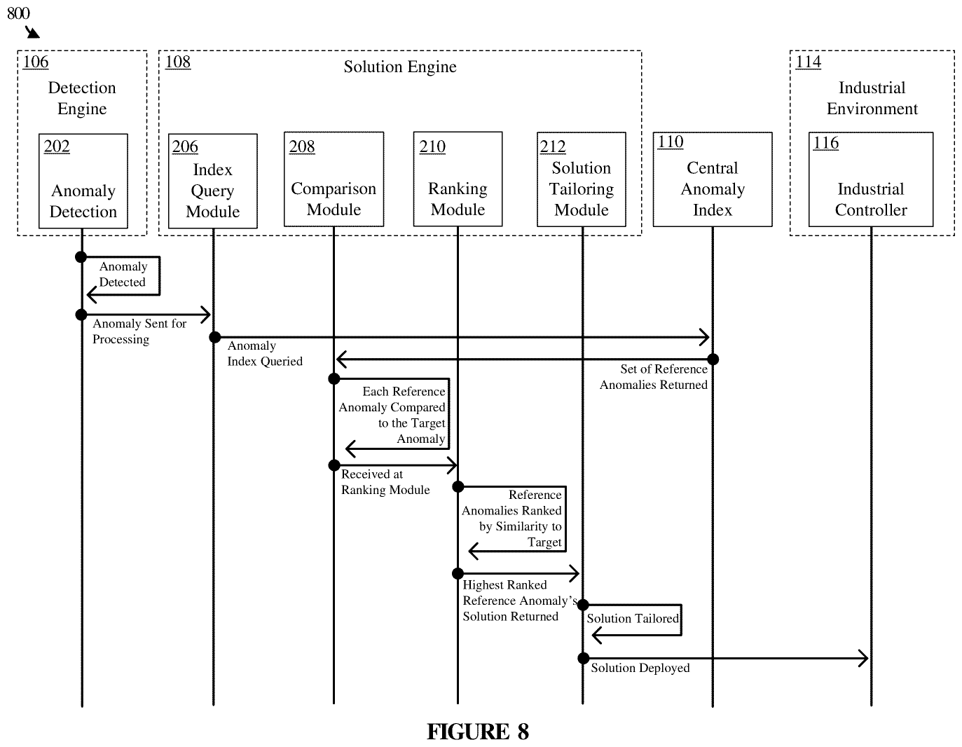

FIG. 8 illustrates software flow diagram 800 depicting a further example application of the automated anomaly detection and resolution system 100. Flow diagram 800 corresponds with method 500. Flow diagram 800 is similar to flow diagram 600 except central anomaly index 110 is queried for a set of reference anomalies instead of a single reference anomaly solution.

Upon receiving the target anomaly information collected by anomaly detector 202, index query module 206 generates a prompt that directs central anomaly index 110 to return a set of reference anomalies. The prompt includes the target anomaly information. The central anomaly index is configured to receive the prompt and return a set of reference anomalies to comparison module 208. The set of reference anomalies are selected by central anomaly index 110 with respect to the target anomaly information.

In response to receiving the output from central anomaly index 110, comparison module 208 evaluates each reference anomaly of the set of reference anomalies by comparing each reference anomaly to the target anomaly. The comparison is made with respect to the anomaly information for each reference anomaly and the target anomaly information. The evaluated comparisons are sent to ranking module 210 for further processing.

Ranking module 210 ranks each reference anomaly of the set of reference anomalies based on a degree of similarity to the target anomaly. The highest ranked anomaly is the reference anomaly of the set of reference anomalies with the highest degree of similarity to the target anomaly. The highest ranked reference anomaly is selected, and the associated reference anomaly solution is sent to solution tailoring module 212 for further processing. Once the reference anomaly solution is received at solution tailoring module 212, the remaining steps of the method described in FIG. 8 and the remaining steps of the method described in FIG. 6 are the same.

FIG. 9 illustrates example computing system 900 used in some embodiments of the present technology. Computing system 905 is representative of any system or collection of systems with which the various operational architectures, processes, scenarios, and sequences disclosed herein for implementation of an automated anomaly detection and resolution system may be employed. Computing system 905 may be implemented as a single apparatus, system, or device or may be implemented in a distributed manner as multiple apparatuses, systems, or devices. Computing system 905 includes, but is not limited to, processing system 925, storage system 910, software 915, communication interface system 920, and user interface system 930. Processing system 925 is operatively coupled with storage system 910, communication interface system 920, and user interface system 930. Computing system 905 may be representative of a cloud computing device, distributed computing device, or the like.

Processing system 925 loads and executes software 915 from storage system 910. Software 915 includes and implements Automated Anomaly Detection and Resolution System 102. When executed by processing system 925 to automated anomaly detection and resolution, software 915 directs processing system 925 to operate as described herein for at least the various processes, operational scenarios, and sequences discussed in the foregoing implementations. Computing system 905 may optionally include additional devices, features, or functionality not discussed for purposes of brevity.

Processing system 925 may comprise a microprocessor and other circuitry that retrieves and executes software 915 from storage system 910. Processing system 925 may be implemented within a single processing device but may also be distributed across multiple processing devices or sub-systems that cooperate in executing program instructions. Examples of processing system 925 include general purpose central processing units, graphical processing units, application specific processors, and logic devices, as well as any other type of processing device, combinations, or variations thereof.

Storage system 910 may comprise any computer readable storage media readable by processing system 925 and capable of storing software 915. Storage system 910 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations, storage system 910 may also include computer readable communication media over which at least some of software 915 may be communicated internally or externally. Storage system 910 may be implemented as a single storage device but may also be implemented across multiple storage devices or sub-systems co-located or distributed relative to each other. Storage system 910 may comprise additional elements, such as a controller capable of communicating with processing system 925 or possibly other systems.

Software 915 (including Automated Anomaly Detection and Resolution System 102) may be implemented in program instructions and, when executed by processing system 925, can direct processing system 925 to operate as described with respect to the various operational scenarios, sequences, and processes illustrated herein. For example, software 915 may include program instructions for implementing automated anomaly detection and resolution.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 915 may include additional processes, programs, or components, such as operating system software, virtualization software, or other application software. Software 915 may also comprise firmware or some other form of machine-readable processing instructions executable by processing system 925.

In general, software 915 may, when loaded into processing system 925 and executed, transform a suitable apparatus, system, or device (of which computing system 905 is representative) overall from a general-purpose computing system into a special-purpose computing system customized to provide automated anomaly detection and resolution as described herein. Indeed, encoding software 915 on storage system 910 may transform the physical structure of storage system 910. The specific transformation of the physical structure may depend on various factors in different implementations of this description. Examples of such factors may include, but are not limited to, the technology used to implement the storage media of storage system 910 and whether the computer-storage media are characterized as primary or secondary storage, as well as other factors.

For example, if the computer readable storage media are implemented as semiconductor-based memory, software 915 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 920 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 905 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

While some examples provided herein are described in the context of an industrial automation environment, it should be understood that the automated anomaly detection and resolution systems and methods described herein are not limited to such embodiments and may apply to a variety of other industrial environments and their associated systems. As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method of anomaly detection and resolution, the method comprising:
detecting, by an anomaly detection engine, a target anomaly in an industrial automation system (IAS), wherein the detecting comprises detecting a target anomaly description, a target anomaly context, and a code block source of the target anomaly, and wherein the IAS comprises one or more industrial devices controlled by one or more industrial controllers;
identifying, by an anomaly solution engine, a reference anomaly solution;
generating, at the anomaly solution engine, a target anomaly solution, wherein generating the target anomaly solution comprises modifying the reference anomaly solution based at least in part on the target anomaly context to tailor the reference anomaly solution for application to the target anomaly; and
deploying the target anomaly solution to the IAS.

2. The method of anomaly detection and resolution of claim 1, wherein:
deploying the target anomaly solution to the IAS further includes a debug loop, the debug loop comprising:
evaluating, at the anomaly solution engine, an application of the target anomaly solution to the IAS,
distinguishing the application of the target anomaly solution from the reference anomaly solution,
modifying the target anomaly solution to emulate the reference anomaly solution, and
repeating the debug loop until differences identified in the distinguishing are below a threshold value.

3. The method of claim 1, wherein identifying the reference anomaly solution comprises:
querying a central anomaly index for a set of reference anomalies based at least in part on the target anomaly context,
comparing, for each reference anomaly in the set of reference anomalies, an anomaly context of each respective reference anomaly with the target anomaly context and an anomaly description of each respective reference anomaly with the target anomaly description,
ranking each reference anomaly in the set of reference anomalies based on a degree of similarity determined from the comparing, and
acquiring a reference anomaly solution from the central anomaly index, wherein the reference anomaly solution is associated with the highest ranked reference anomaly.

4. The method of anomaly detection and resolution of claim 1, wherein detecting the target anomaly further includes a logging of the target anomaly in an anomaly logger.

5. The method of anomaly detection and resolution of claim 1, wherein the target anomaly comprises a nonconforming data entry in the IAS, an unexpected behavior in the IAS, a nonconforming output in the IAS, a logic fault in the IAS, or a combination thereof.

6. The method of anomaly detection and resolution of claim 1, wherein:
the target anomaly context includes a pre-anomaly state of the IAS, wherein a pre-anomaly state of the IAS includes one or more precedent logical states of the IAS, one or more precedent register values of a processor in the IAS, one or more precedent actions of a device or controller of the IAS, one or more precedent anomalies in the IAS, or a combination thereof, and
the target anomaly comprises one or more precedent conditions that induce a nonconforming data entry in the IAS, an unexpected behavior in the IAS, a nonconforming output in the IAS, a logic fault in the IAS, or a combination thereof.

7. The method of anomaly detection and resolution of claim 1, wherein detecting the target anomaly comprises:
polling the IAS based on:
an automated analysis of a codebase underlying the IAS;
a user-initiated analysis of a codebase underlying the IAS; or
a combination thereof.

8. The method of anomaly detection and resolution of claim 1, wherein generating a target anomaly solution further comprises:
replicating, at a central anomaly index, a topology of the IAS.

9. The method of anomaly detection and resolution of claim 1, wherein training data for the anomaly solution engine includes one of safety standards data, industry standards data, industry best practices data, internal procedures data, internal documentation data, device documentation data, or a combination thereof.

10. The method of claim 1, further comprising:
training the anomaly detection engine using data from a central anomaly index.

11. The method of claim 1, further comprising:
logging the target anomaly and solution;
determining the target anomaly solution resolves the target anomaly; and
feeding the log of the target anomaly and solution back to a central anomaly index.

12. An anomaly detection and resolution system, comprising:
an anomaly detection engine configured to detect a target anomaly in an industrial automation system (IAS), wherein:
the detecting comprises detecting a target anomaly description, a target anomaly context, and a code block source of the target anomaly, and
the IAS comprises one or more industrial devices controlled by one or more industrial controllers; and
an anomaly solution engine configured to:
generate a target anomaly solution, wherein generating the target anomaly solution comprises:
identifying a reference anomaly solution; and
modifying the reference anomaly solution based at least in part on the target anomaly context to tailor the reference anomaly solution for application to the target anomaly, and
in response to generating the target anomaly solution, deploy the target anomaly solution to the IAS.

13. The anomaly detection and resolution system of claim 12, wherein the anomaly solution engine is further configured to:
execute a debug loop, comprising:
evaluating, at the anomaly solution engine, an application of the target anomaly solution to the IAS,
distinguishing the application of the target anomaly solution from the reference anomaly solution to generate identified differences, and
modifying the target anomaly solution to emulate the reference anomaly solution; and
repeat the debug loop until the identified differences are below a threshold value.

14. The anomaly detection and resolution system of claim 12, wherein identifying the reference anomaly solution comprises:
querying a central anomaly index for a set of reference anomalies based at least in part on the target anomaly context,
comparing, for each reference anomaly in the set of reference anomalies, an anomaly context of each respective reference anomaly with the target anomaly context and an anomaly description of each respective reference anomaly with the target anomaly description,
ranking each reference anomaly in the set of reference anomalies based on a degree of similarity determined from the comparing, and
acquiring a reference anomaly solution from the central anomaly index, wherein the reference anomaly solution is associated with the highest ranked reference anomaly.

15. The anomaly detection and resolution system of claim 12, wherein detecting the target anomaly further includes a logging of the target anomaly in an anomaly logger.

16. The anomaly detection and resolution system of claim 12, wherein the target anomaly comprises a nonconforming data entry in the IAS, an unexpected behavior in the IAS, a nonconforming output in the IAS, a logic fault in the IAS, or a combination thereof.

17. The anomaly detection and resolution system of claim 12, wherein:
the target anomaly context includes a pre-anomaly state of the IAS, wherein a pre-anomaly state of the IAS includes one or more precedent logical states of the IAS, one or more precedent register values of a processor in the IAS, one or more precedent actions of a device or controller of the IAS, one or more precedent anomalies in the IAS, or a combination thereof, and
the target anomaly comprises one or more precedent conditions that induce a nonconforming data entry in the IAS, an unexpected behavior in the IAS, a nonconforming output in the IAS, a logic fault in the IAS, or a combination thereof.

18. The anomaly detection and resolution system of claim 12, wherein the detecting the target anomaly comprises:
polling the IAS based on:
an automated analysis of a codebase underlying the IAS;
a user-initiated analysis of a codebase underlying the IAS; or
a combination thereof.

19. The anomaly detection and resolution system of claim 12, wherein generating a target anomaly solution further comprises:
replicating, at a central anomaly index, a topology of the IAS.

20. The anomaly detection and resolution system of claim 12, wherein training data for the anomaly solution engine includes one of safety standards data, industry standards data, industry best practices data, internal procedures data, internal documentation data, device documentation data, or a combination thereof.
